(19) United States
(12) Patent Application Publication
(10) Pub. No.: US 2006/0119204 A1
(43) Pub. Date: Jun. 8, 2006

(54) Permanent magnet motor and washing machine provided therewith

(75) Inventors: Minoru Awazu, Yokohama (JP); Isamu Nitta, Yokohama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/284,925

(22) Filed: Nov. 23, 2005

(30) Foreign Application Priority Data
Nov. 25, 2004 (JP) 2004-340473
Nov. 25, 2004 (JP) 2004-340475

(51) Int. Cl. H02K 21/12

(52) U.S. Cl. 310/156.53

(57) ABSTRACT

A permanent magnet motor includes a stator, a rotor including a rotor core made of a magnetic material and incorporated with a number of permanent magnets of a plurality of magnetic poles and a frame made of a magnetic material and having an inner periphery on which the permanent magnets are disposed and a bottom, the rotor being disposed so as to be located radially outside the stator, and a non-magnetic material filling a space between the rotor core and the bottom of the frame.

### CROSS-REFERENCE TO RELATED APPLICATIONS

This application is based upon and claims the benefit of priority from the prior Japanese Patent Application Nos. 2004-340473 and 2004-340475, both filed on Nov. 25, 2004, the entire contents of both of which are incorporated herein by reference.

### BACKGROUND OF THE INVENTION

1. Field of the invention

The present invention relates to a permanent magnet motor comprising a rotor core made of a magnetic material and permanent magnets assembled into the rotor core and a washing machine provided with the permanent magnet motor as a drive source.

2. Description of the related art

Conventional permanent magnet motors of the outer rotor type in which a rotor is disposed outside a stator comprise a rotor including a rotor core and a frame. The rotor core is made of a magnetic material and incorporated with permanent magnets of a plurality of magnetic poles. The annular frame is also made of a magnetic material and has an inner circumference along which the rotor core is disposed. JP-A-2004-254403 discloses one the above-described type permanent magnet motor, for example. The frame necessitates a mechanical strength sufficient to support the rotor core incorporated with the permanent magnets in the above-described motor. Accordingly, the frame is made of a magnetic material such as steel plate.

The above-described permanent magnet motor has a problem that magnetic flux of the permanent magnets tends to leak from the rotor core. More specifically, the rotor core is in abutment with a bottom of the frame in the foregoing conventional permanent magnet motor. As a result, magnetic flux leaks from rotor core toward the frame bottom such that the magnetic flux of the permanent magnets cannot effectively be utilized between the rotor and the stator. This results in a problem that magnetic flux cannot effectively be used for rotation of the rotor.

Furthermore, the rotor core is generally made by stacking a plurality of steel plates. The steel plate includes intervening portions located between magnet insertion holes and the stator respectively. Each intervening portion has both circumferential ends connected to a main body of the rotor core. Both circumferential ends of each intervening portion form a magnetic path along which magnetic flux of permanent magnets tends to pass. Accordingly, since magnetic flux tends to leak from the circumferential ends of each intervening portion. In this case, too, the magnetic flux of the permanent magnets cannot effectively be utilized between the rotor and the stator. This results in a problem that magnetic flux cannot effectively be used for rotation of the rotor. In this case, both ends of each intervening portion are suggested to have respective openings which communicate with the magnet insertion hole and are open at the stator side. However, when the permanent magnet motor is constructed as described above, the rotor cannot easily be assembled, since each intervening portion is separated from the main body of the rotor core. Thus, the aforesaid suggestion has a problem of manufacturing efficiency.

### SUMMARY OF THE INVENTION

Therefore, an object of the present disclosure is to provide a permanent magnet motor which can prevent leakage of magnetic flux of permanent magnets from the rotor core made of a magnetic material and incorporated with permanent magnets and can accordingly realize effective utilization of the magnetic flux and improve motor output power.

To achieve the object, the present disclosure provides a permanent magnet motor comprising a stator, a rotor including a rotor core made of a magnetic material and incorporated with a number of permanent magnets of a plurality of magnetic poles and a frame made of a magnetic material and having an inner periphery on which the permanent magnets are disposed and a bottom, the rotor being disposed so as to be located radially outside the stator, and a non-magnetic material filling a space between the rotor core and the bottom of the frame.

In the above-described permanent magnet motor, the non-magnetic material filling the space between the rotor core and the frame bottom prevents leakage of magnetic flux from the rotor core to the frame bottom. Consequently, an effective utilization of magnetic flux can be realized and accordingly, motor output power can be improved.

To achieve the same object, a space is defined between the rotor core and the bottom of the frame, instead of the non-magnetic material.

The present disclosure further provides a permanent magnet motor comprising a stator, a rotor including a rotor core made by stacking a plurality of steel plates and having a plurality of magnet insertion holes formed therein so as to be aligned peripherally and permanent magnets serving as field magnets and inserted in the magnet insertion holes respectively, the rotor being disposed so as to be opposed to the stator from a radial direction, the rotor core including a first steel plate having a main portion and an intervening portion intervening between each magnet insertion hole and the stator and having both peripheral ends formed with openings which communicate with the corresponding magnet insertion hole and are open at the stator side so that the intervening portion is independent of the main portion, the rotor core further including a second steel plate having a main portion and an intervening portion having both peripheral ends at least one of which is connected to the main portion, the intervening portions and the main portions of the first and second steel plates being connected to each other in a direction of stacking, and a resin provided between the peripherally adjacent intervening members so as to cover the peripheral ends of each intervening portion, the resin limiting displacement of each intervening portion to the stator side.

In the above-described motor, since the openings are formed in both ends of each intervening portion of the first steel plate, an amount of magnetic flux leakage can be reduced. In this case, although each intervening portion of the first steel plate is independent of the main portion, the intervening portion of the second steel plate has at least one end connected to the main portion. The intervening portions of the first steel plates are connected to the intervening portions of the second steel plates, and the main portions of the first steel plates are connected to the main portions of the second steel plates. Consequently, since the intervening portions of the first steel plates can be treated together with the other portions, high manufacturing efficiency can be ensured and the manufacturing accuracy can be improved.

Furthermore, a resin is provided between the peripherally adjacent intervening members so as to cover the peripheral ends of each intervening portion, the resin limiting displacement of each intervening portion to the stator side. Consequently, each intervening portion can be prevented from displacement to the stator side. With this, a gap between the stator and rotor can be reduced to a value as small as possible.

### BRIEF DESCRIPTION OF THE DRAWINGS

Other objects, features and advantages of the present invention will become clear upon reviewing the following description of the illustrative aspect with reference to the accompanying drawings, in which:

FIG. 1 is a longitudinal section of a rotor of the permanent magnet motor according to a first illustrative aspect of the invention;

FIG. 2 is a broken perspective view of the motor;

FIG. 3 is a broken perspective view of a frame and a rotor core;

FIG. 4 is a plan view of a part of the rotor core;

FIG. 5 is a broken side section of an automatic washing machine;

FIG. 6 is a view similar to FIG. 1, showing the permanent magnet motor according to a second illustrative aspect;

FIG. 7 is a plan view of a part of the rotor core of a permanent magnet motor according to a third illustrative aspect;

FIG. 8 is a view similar to FIG. 2;

FIG. 9 is a broken perspective view of the rotor core (divided core);

FIG. 10A is a plan view of a second steel plate; and

FIG. 10B is a plan view of first steel plate.

### DETAILED DESCRIPTION OF THE INVENTION

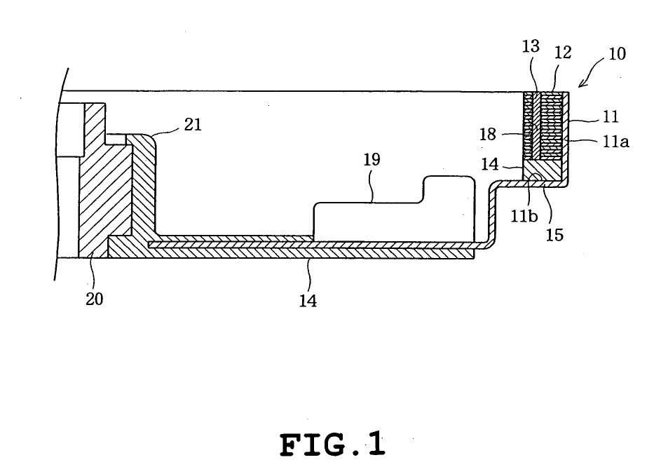

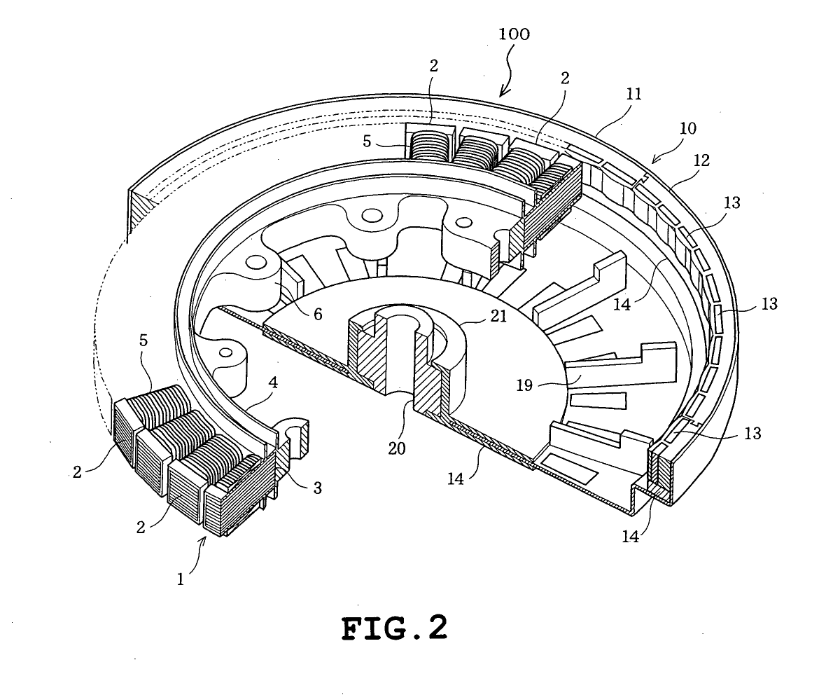

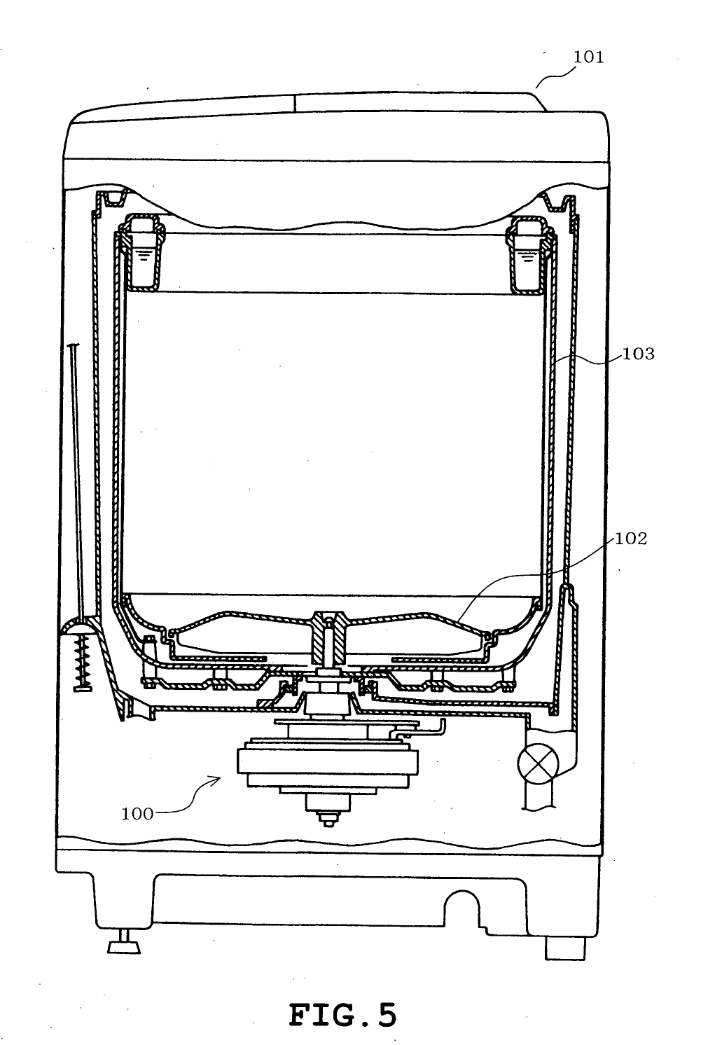

A first embodiment of the present invention will be described with reference to FIGS. 1 to 5. Referring to FIG. 2, a permanent magnet motor 100 of the outer rotor type is shown. The motor 100 is used as a drive motor for rotating an agitator 102 during a wash step and for rotating both the agitator and a rotating tub 103 during a dehydration step in an automatic washing machine 101 as shown in FIG. 5. The rotating tub 103 thus serves as a wash tub and a dehydration tub.

The permanent magnet motor 100 includes a stator 1 and a rotor 10. The stator 1 further includes an annular stator core 3 with a number of radially extending teeth 2, a resin covering the stator core 3 or particularly a compact 4, and a stator winding 5 wound on the teeth 2 with the compact 4 being interposed therebetween. The stator core 3 is made by stacking a number of silicon steel plates. The stator 1 has a plurality of mounting portions 6 formed on an inner periphery thereof. The mounting portions 6 are to be mounted on predetermined portions of the washing machine respectively.

The rotor 10 includes a circular shallow receptacle-shaped frame 11, a rotor core 12 disposed on an inner periphery of the frame 11, a plurality of permanent magnets 13 incorporated in the rotor core 12, and a resin or a molding 14 made of a synthetic resin. The molding 14 fills a space between the permanent magnets 13 and the rotor core 12, a space between rotor core 12 and the frame 11 and a space between magnetic poles of the rotor core 12, as will be described later. The rotor 10 is disposed so that an inner periphery (distal end of each magnetic pole) of the rotor core 12 opposes distal ends of teeth 2 of the stator core 3 from the radial direction with a predetermined gap therebetween. Accordingly, the rotor core 12 is located radially outside the stator 1.

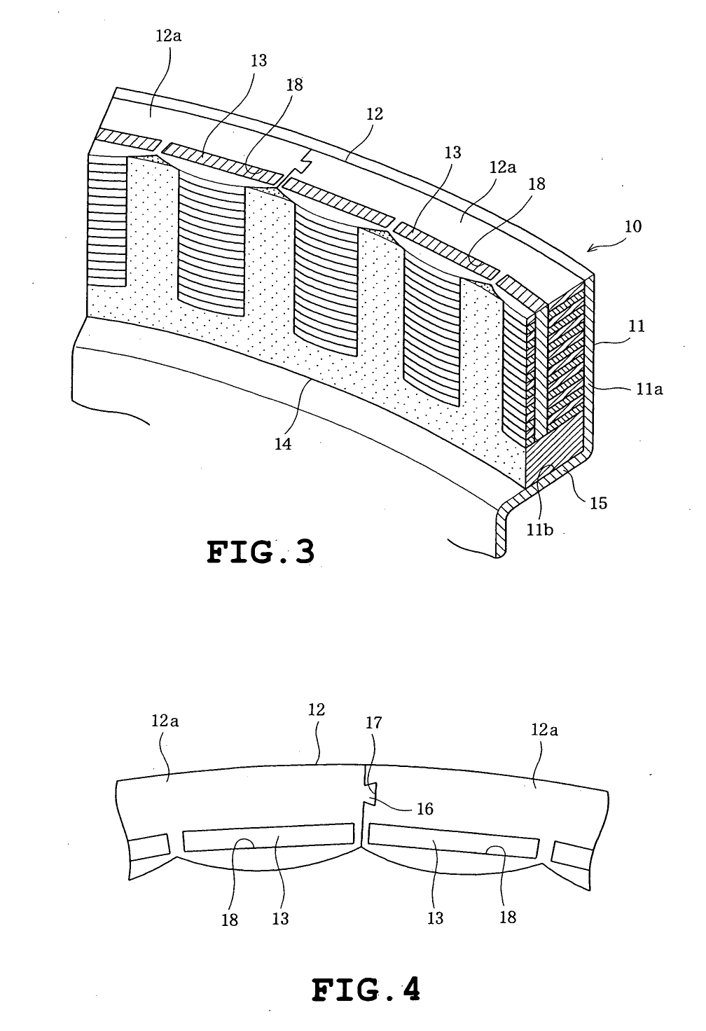

The frame 11 is made of a magnetic material or more particularly a soft magnetic material such as a steel plate. The frame 11 includes a peripheral wall 11a having a stepped portion 15 as shown in FIGS. 1 and 3. The rotor core 12 is disposed on an upper part of the peripheral wall 11a located at an open side of the frame. The rotor core 12 is made by stacking a plurality of silicon steel plates which is a soft magnetic material in a similar manner as the stator core 3 is made. Thus, the rotor core 12 is formed into a laminated core. Furthermore, the rotor core 12 is divided into a plurality of, for example, six peripherally divided core pieces 12a. The divided core pieces 12a are assembled into an annular shape by fitting dovetail-tenon-like fitting portions 16 into dovetail-groove-like fitted portions 17 respectively.

The rotor core 12 is formed with a plurality of magnet insertion holes 18 serving as magnet accommodating portions, the number of which holes corresponds to the number of magnetic poles. The permanent magnets 13 are accommodated in the magnet insertion holes 18 respectively, whereby a plurality of permanent magnets are incorporated in the rotor core 12. Each portion of the rotor core 12 into which the permanent magnet 13 is incorporated constitutes a magnetic pole together with the permanent magnet 13. Each magnetic pole section has a distal end which is formed into a columnar shape and includes a central part higher than both ends. A sintered neodymium magnet is employed as the permanent magnet 13.

The molding 14 is made by filling, with the resin, the space between the permanent magnets 13 and the rotor core 12, the space between the rotor core 12 and the frame 11 and a space between magnetic poles of the rotor core 12, as described above. Accordingly, the molding 14 is present in the aforesaid spaces and particularly, in a space between the rotor core 12 and a bottom 11b of the stepped portion 15 of the frame 11, whereby the space between the rotor core 12 and a bottom 11b of the frame 11 is filled with the resin. Since the resin (molding 14) is a non-magnetic material, the space between the rotor core 12 and a bottom 11b of the frame 11 is filled with the non-magnetic material. The bottom 11b of the frame 11 is opposed to an axially inner surface or an underside of the rotor core.

The molding 14 is further provided near a number of fins or blades 19 and a shaft support 21 in which a bearing collar is embedded.

According to the foregoing embodiment, the permanent magnet motor of the outer rotor type includes the rotor core 12 (laminated core) made of the magnetic material and incorporated with the permanent magnets 13 of a plurality of magnetic poles. The rotor core 13 is disposed on the inner periphery of the frame 11. The space between the rotor core 12 and the bottom 11b of the frame 11 is filled with the non-magnetic material (the molding 14 (resin)). As a result, the non-magnetic material filling the space between the rotor core 12 and the bottom 11b of the frame 11 prevents leakage of magnetic flux of the permanent magnets 13 from the rotor core 12 to the bottom 11b of the frame 11. Consequently, effective utilization of the magnetic flux can be realized and motor output power can be improved.

Particularly when the sintered neodymium magnet is employed as the permanent magnet 13, neodymium is expensive and effective utilization of magnetic flux is necessitated for reduction in the size of the magnet and in the number of magnets. Accordingly, the above-described permanent magnet motor of the embodiment meets the necessity and accordingly, realization of the effective utilization of the magnetic flux can be evaluated.

Furthermore, the rigidity of the rotor 10 can be improved as the result of filling, with the non-magnetic material, the space between the rotor core 12 and the bottom 11b of the frame 11. Consequently, oscillation and noise of the motor can be reduced. In the foregoing embodiment, particularly, the resin fills the space between the rotor core 12 and the permanent magnets 13 thereby to bond the rotor core 12 and the permanent magnets 13 to each other. The resin also fills the space between the rotor core 12 and the frame 11 thereby to bond the rotor core 12 and the frame 11 to each other. Thus, the improvement in the motor output power and reduction in oscillation and noise can be achieved by utilizing the resin provided for bonding the rotor core 12 and the permanent magnet 13 to each other and the rotor core 12 and the frame 11 to each other. Consequently, utility of the material can be improved.

Furthermore, the rotor core 12 is peripherally divided into a plurality of pieces. Accordingly, when a steel plate to be used for rotor core 12 is stamped out of a material, an amount of wasted material can be reduced and the cost of the permanent magnet motor can be reduced. Further, the non-magnetic material (resin) can contribute to improvement in the bondage of the aforesaid members.

Additionally, the output power of the permanent magnet motor 100 of the outer rotor type can be improved as the result of provision of the aforesaid rotor 10. The permanent magnet motor 100 can be used as a drive source of the washing machine. Consequently, a high level washing performance and a high level dehydrating performance can be achieved.

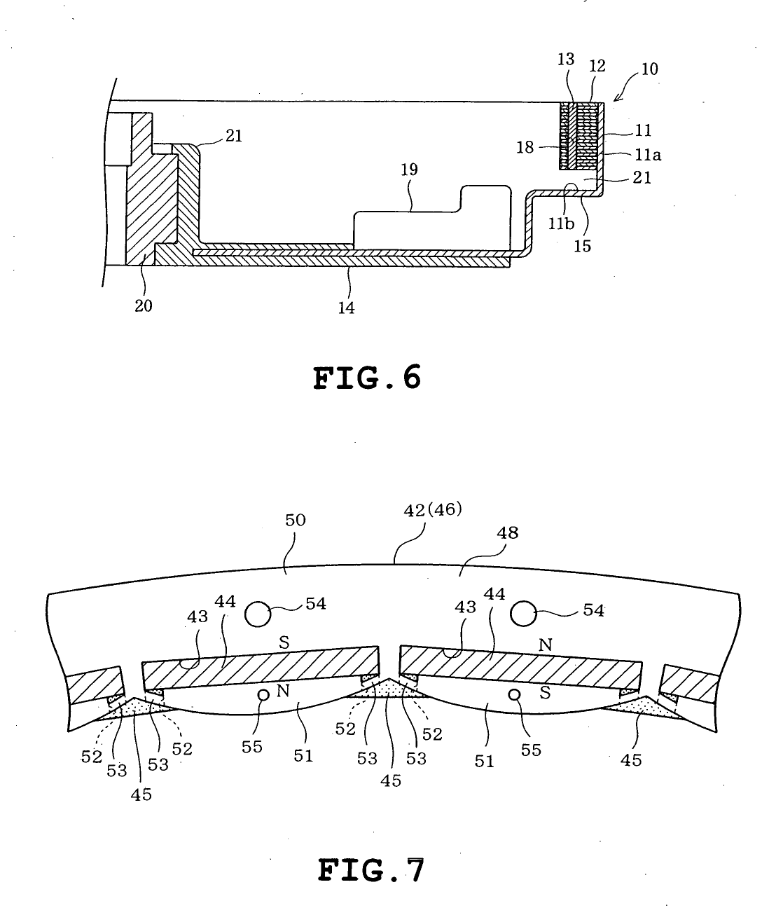

FIG. 6 illustrates a second embodiment of the invention. In the second embodiment, identical or similar parts are labeled by the same reference symbols as those in the first embodiment, and the description of the identical parts will be eliminated. Only the differences of the second embodiment from the first embodiment will be described later.

In the second embodiment, a space 21 is provided between the rotor core 12 and the bottom 11b of the frame 11, instead of the non-magnetic material filling the space. It is desirable that a dimension between the rotor core 12 and the bottom 11b of the frame 11 should be not less than 3 mm. The dimension is 8 mm in the embodiment.

According to the second embodiment, the space 21 between the rotor core 12 and the bottom 11b of the frame 11 prevents leakage of magnetic flux of the permanent magnets 13 from the rotor core 12 to the bottom 11b of the frame 11. Consequently, effective utilization of the magnetic flux can be realized and motor output power can be improved as in the first embodiment.

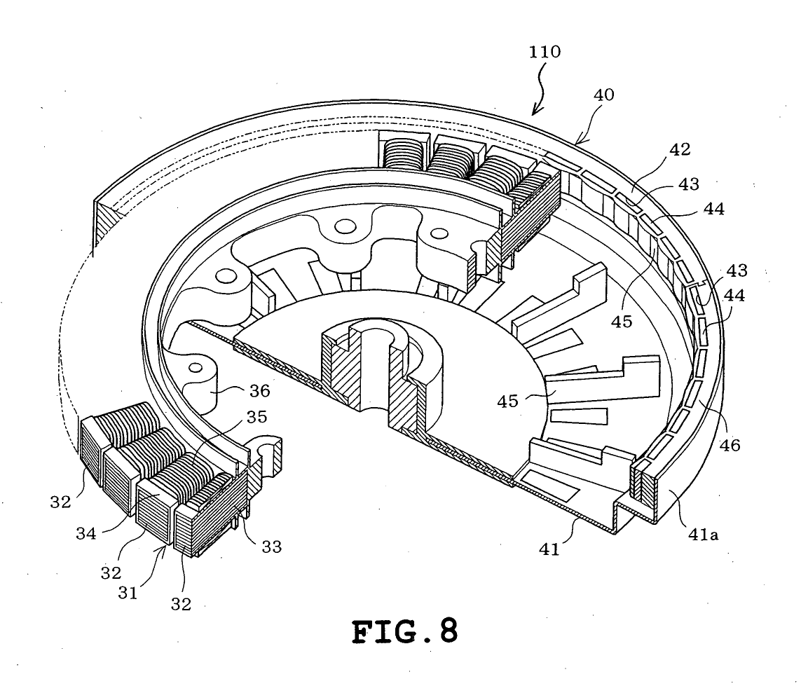

FIGS. 7 to 10B illustrate a third embodiment of the invention. Referring first to FIG. 8, a permanent magnet motor 110 of the outer rotor type is shown. The permanent magnet motor 110 is also used as a drive motor (a drive source) for rotating an agitator during a wash step and both the agitator and a rotating tub during a dehydration step in an automatic washing machine as in the first embodiment.

Referring now to FIG. 8, a stator 31 of the permanent magnet motor 110 comprises a stator core 33 having a number of radially extending teeth 32, a resin 34 provided by molding so as to cover the stator core 33 and a stator winding 35 wound on the teeth 32. The stator core 33 is made by stacking a plurality of silicon steel plates on the stator core 33 and formed into an annular shape. The stator 31 has a plurality of mounting portions 36 formed on an inner periphery thereof. The mounting portions 36 are to be mounted on predetermined portions of the washing machine respectively.

A rotor 40 includes a generally receptacle-shaped frame 41 made of a magnetic material and having an annular wall 41a formed on an outer periphery of the frame 41, an annular rotor core 42 disposed on an inner periphery of the annular wall 41a, a number of permanent magnets for magnetic field inserted in a number of magnet insertion holes 43 formed in the inner periphery of the rotor core 42 respectively, and a resin 45 provided by the molding so that the rotor core 42, the permanent magnets 44 and the frame 41 are secured together thereby to be integrated. The rotor 40 is disposed so that an inner periphery of the rotor core 42 opposes distal ends of teeth 32 of the stator core 33 from the radial direction with a predetermined gap therebetween. In this case, forty-eight permanent magnets 44 in total are disposed. A rotational shaft (not shown) extends through a central hole (not shown) of the rotor 40.

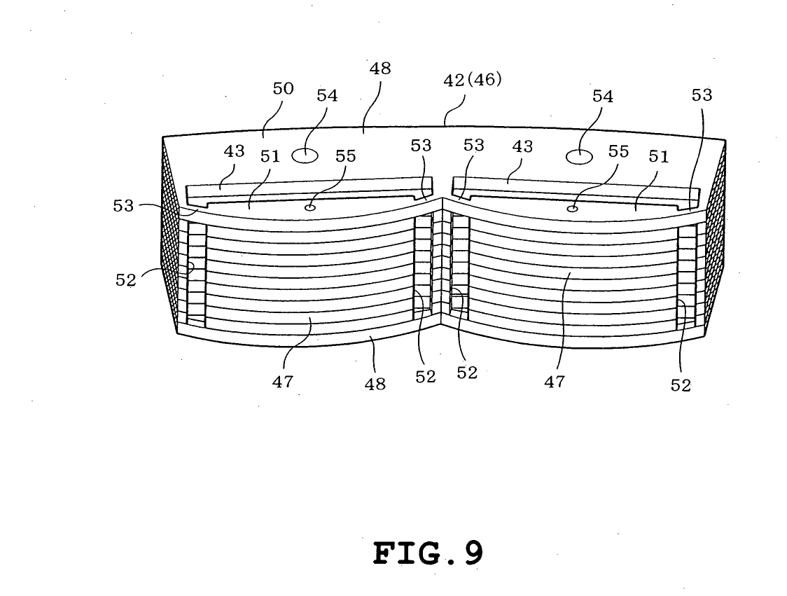

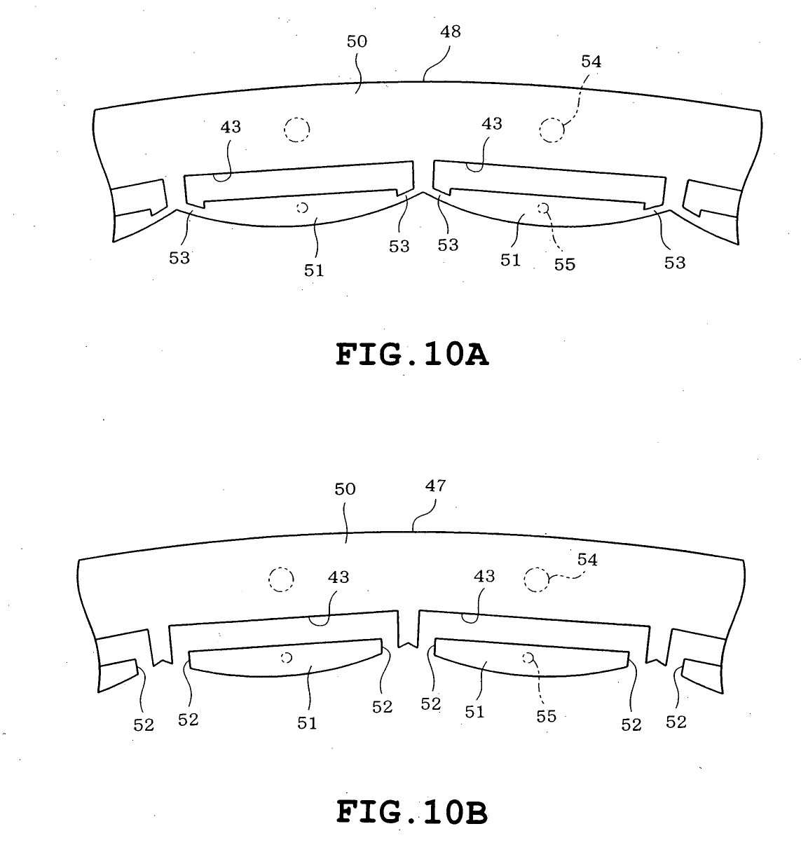

The rotor core 42 is divided into a plurality of, for example, six peripherally divided core pieces 46. The divided core pieces 46 are connected to one another into an annular shape. Each divided core piece 46 includes first steel sheets 47 and second steel sheets 48 each of which is made of a silicon steel plate and which are stacked as shown in FIG. 9. Each first steel plate 47 includes a base 50 and a generally crescent intervening portion 51 separated from the base 50 with the magnet insertion hole 43 being interposed therebetween, as shown in FIG. 10B. Each intervening portion 51 has both peripheral ends formed with openings 52 respectively. Each intervening portion 51 is located between the corresponding magnet insertion hole 43 and the stator 31. Both openings 52 of each intervening portion 51 communicate with the magnet insertion hole 43 and are open to the stator 31 side. Each second steel plate 48 includes a base 50 and a generally crescent intervening portion 51 both joined to each other at both peripheral ends of each intervening portion 51 with respective connecting portions 53, as shown in FIG. 10A.

In this case, as shown in FIG. 9, a plurality of first steel sheets 47 are stacked on a single second steel plate 48. A single second steel plate 48 is stacked on an uppermost plate. The bases 50 of the steel plates 47 and 48 are connected together by a calking 54 in a stacking direction, whereas the intervening portions 51 are connected together by a calking 55 in a stacking direction. Each divided core piece 46 is sized so as to include eight magnet insertion holes 43, for example. Each magnet insertion hole 43 is formed into a peripherally elongate rectangular shape. Each permanent magnet 44 inserted into the corresponding magnet insertion hole 43 is a sintered neodymium magnet which is formed into the shape of a flat plate so as to correspond to the magnet insertion hole 43. Furthermore, the permanent magnets 44 are magnetized so that the permanent magnets adjacent to each other have poles reverse to each other (see FIG. 7).

The aforesaid resin 45 is provided so as to cover the peripheral ends of the intervening portions peripherally adjacent to each other. The magnet insertion holes 43 and the aforesaid openings 52 are also filled with the resin 45.

The following effects can be achieved from the above-described construction. Firstly, in each divided core piece 46 of the rotor core 43, the openings 52 are formed in both ends of each intervening portion 51 in a part where the first steel plates 47 are stacked. Since a magnetic resistance is rendered larger in this portion, the leakage of magnetic flux of each permanent magnet inserted in each magnet insertion hole 43 can be reduced, whereupon the magnetic flux of each permanent magnet 44 can act upon the stator via the intervening portion 51 as effectively as possible. In this case, although the intervening portion 51 of each first steel plate 47 is independent of the base 50, the intervening portions 51 of the second steel plates 48 sandwiching the first steel plate have both ends connected via the connecting portions 53 to the bases 50. Accordingly, the intervening portion 51 of each first steel plate 47 is connected to the intervening portion 51 of the second steel plate 48 by the calk 50, and the base 50 of each first steel plate 47 is connected to the base 50 of each second plate 48 by the calk 54. As a result, since the intervening portions 50 of the first steel plates 47 can be treated as being integral with the other part, high manufacturing efficiency can be ensured and the manufacturing accuracy can be improved.

Furthermore, since the resin 45 covering the peripheral ends of the intervening portions 51 peripherally adjacent to each other, each intervening portion 51 can be restrained from displacement to the stator 31 side. The construction is effective particularly when there is a part where the intervening portion is separated from the base 50 in the construction of the embodiment. With this, the gap between the stator 31 and the rotor 40 can be rendered as small as possible and accordingly, the size of the permanent magnet motor can be reduced. Furthermore, since the accuracy of the gap between the stator 31 and the rotor 40 is improved, motors with reduced noise and oscillation can be manufactured.

The rotor core 42 is divided into a plurality of peripherally divided core pieces 46. Furthermore, each divided core piece 46 is made by stacking a plurality of steel plates 47 and 48. As a result, the steel plate can be used more effectively as compared with the case where the rotor core 42 is formed by stacking annular steel plates. When the circular annular steel plate is used, an amount of left portion is large and accordingly, an amount of loss is increased. In the above-described construction, however, an amount of loss in the steel plate can be rendered as small as possible.

The invention should not be limited to the above-described embodiments but may be modified or expanded as follows. In the third embodiment, both ends of each intervening portion 51 are connected via the connecting portions 53 to the base 50 in each second steel plate 48, respectively. However, at least one of the ends of each intervening portion 51 may be connected to the base 50.

The permanent magnet motor of the invention may be used as a drive source for driving a drum or rotating tub provided so as to be rotatable about a substantially horizontal axis.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A permanent magnet motor comprising:
a stator;
a rotor including a rotor core made of a magnetic material and incorporated with a number of permanent magnets of a plurality of magnetic poles and a frame made of a magnetic material and having an inner periphery on which the permanent magnets are disposed and a bottom, the rotor being disposed so as to be located radially outside the stator; and
a non-magnetic material filling a space between the rotor core and the bottom of the frame.

2. The permanent magnet motor according to claim 1, wherein the non-magnetic material comprises a resin filling a space between the rotor core and the permanent magnets thereby to bond the rotor core and the permanent magnets to each other or a resin filling a space between the rotor core and the frame thereby to bond the rotor core and the frame to each other.

3. A permanent magnet motor comprising:
a stator;
a rotor including a rotor core made of a magnetic material and incorporated with a number of permanent magnets of a plurality of magnetic poles and a frame made of a magnetic material and having an inner periphery on which the permanent magnets are disposed and a bottom, the rotor being disposed so as to be located radially outside the stator; and
a space defined between the rotor core and the bottom of the frame.

4. The permanent magnet motor according to claim 1, wherein the rotor core includes a plurality of divided cores peripherally connected to each other.

5. The permanent magnet motor according to claim 3, wherein the rotor core includes a plurality of divided cores peripherally connected to each other.

6. A washing machine including a rotating tub, comprising:
a permanent magnet motor driving the rotating tub and including:
a stator;
a rotor including a rotor core made of a magnetic material and incorporated with a number of permanent magnets of a plurality of magnetic poles and a frame made of a magnetic material and having an inner periphery on which the permanent magnets are disposed and a bottom, the rotor being disposed so as to be located radially outside the stator; and
a non-magnetic material filling a space between the rotor core and the bottom of the frame.

7. A permanent magnet motor comprising:
a stator;
a rotor including a rotor core made by stacking a plurality of steel plates and having a plurality of magnet insertion holes formed therein so as to be aligned peripherally and permanent magnets serving as field magnets and inserted in the magnet insertion holes respectively, the rotor being disposed so as to be opposed to the stator from a radial direction, the rotor core including a first steel plate having a main portion and an intervening portion intervening between each magnet insertion hole and the stator and having both peripheral ends formed with openings which communicate with the corresponding magnet insertion hole and are open at the stator side so that the intervening portion is independent of the main portion, the rotor core further including a second steel plate having a main portion and an intervening portion having both peripheral ends at least one of which is connected to the main portion, the intervening portions and the main portions of the first and second steel plates being connected to each other in a direction of stacking; and
a resin provided between the peripherally adjacent intervening members so as to cover the peripheral ends of each intervening portion, the resin limiting displacement of each intervening portion to the stator side.

8. The permanent magnet motor according to claim 6, wherein the main portions and the intervening portions of the stacked steel plates are connected in the direction of stacking by caulking.

9. The permanent magnet motor according to claim 6, wherein the resin is the same material as a molding resin for securing the rotor core and the permanent magnets.

10. The permanent magnet motor according to claim 6, wherein the rotor core includes a plurality of divided cores peripherally connected to each other.

11. A washing machine including a rotating tub, comprising:
a permanent magnet motor driving the rotating tub and including:
a stator;
a rotor including a rotor core made by stacking a plurality of steel plates and having a plurality of magnet insertion holes formed therein so as to be aligned peripherally and permanent magnets serving as field magnets and inserted in the magnet insertion holes respectively, the rotor being disposed so as to be opposed to the stator from a radial direction, the rotor core including a first steel plate having a main portion and an intervening portion intervening between each magnet insertion hole and the stator and having both peripheral ends formed with openings which communicate with the corresponding magnet insertion hole and are open at the stator side so that the intervening portion is independent of the main portion, the rotor core further including a second steel plate having a main portion and an intervening portion having both peripheral ends at least one of which is connected to the main portion, the intervening portions and the main portions of the first and second steel plates being connected to each other in a direction of stacking; and
a resin provided between the peripherally adjacent intervening members so as to cover the peripheral ends of each intervening portion, the resin limiting displacement of each intervening portion to the stator side.
